(19) United States
(12) Patent Application Publication
(10) Pub. No.: US 2009/0266750 A1
(43) Pub. Date: Oct. 29, 2009

(54) DEVICE FOR SIPHONING OFF FUEL FROM A RESERVOIR

(76) Inventor: Josef Dagn, Kossen (AT)

Correspondence Address: Tom H. Dao;Klein, O'Neill & Singh, LLP, 43 Corporate Park, Suite 204, Irvine, CA, 92606, US

(21) Appl. No.: 12/431,512

(22) Filed: Apr. 28, 2009

(30) Foreign Application Priority Data
Apr. 28, 2008 (DE) 20 2008 005 854

(51) Int. Cl. C02F 1/00; E03B 5/00

(52) U.S. Cl. 210/90; 137/560; 210/123

(57) ABSTRACT

Device for siphoning off fuel from motor vehicles to be scrapped, comprising a tank drilling device, a pump and two circuit valves, a storage tank and a pump nozzle, wherein the circuit valves are switchable between tank drilling device and pump such that the pump conveys fuel from the tank drilling device to the storage tank or from this to the pump nozzle, and wherein the device is provided with a compressed-air connection and the tank drilling device and the pump and the circuit valves are operable or switchable by compressed air.

The invention relates to a device for siphoning off fuel from a reservoir and more particularly to a device for siphoning fuel from motor vehicles to be scrapped and to a device for separating water and fuel.

### CROSS-REFERENCE TO RELATED APPLICATION

This is an ordinary utility application that claims priority to German Utility Model No. DE 20 2008 005 854, filed Apr. 28, 2008, the contents of which are expressly incorporated herein by reference as if set forth in full.

### BACKGROUND

When motor vehicles are scrapped, it is generally required to remove most if not all fluids still contained in the vehicle, such as fuel and oil, before scrapping it. Frequently, the fuel in the fuel tank contains water as an impurity. Thus, even if the fuel can be recovered, such as withdrawing by suction from or pumped out of the fuel tank, it cannot be used without first separating the water from the fuel.

Although prior art siphoning and separator devices are available, there remains a need for different alternatives.

### SUMMARY

The present methods and systems attempt to address this and other needs. Aspects of the present invention comprises a device for siphoning off fuel from a reservoir. The device comprises: a tank drilling device, a pump, two circuit valves, a storage tank, and a pump nozzle, wherein the two circuit valves are switchable between tank drilling device and the pump such that the pump conveys fuel from the tank drilling device to the storage tank or to the pump nozzle, and wherein the device is provided with a compressed-air connection and the tank drilling device, the pump, and the two circuit valves are operable by compressed air.

In other aspects of the present invention, there is provide a device for separating water and fuel, comprising: a separator vessel having a supply pipe for an inlet flow of mixture of fuel and water at a first fuel to water ratio, and a discharge pipe for an outlet flow of fuel and water at a second fuel to water ratio, wherein a device for increasing flow resistance is provided between the supply pipe and the discharge pipe inside the separator vessel so that the second fuel to water ratio is substantially higher than the first fuel to water ratio, and a drain pipe for water is provided on the separator vessel.

In still yet another aspect of the present invention, there is provide a device for separating water and fuel comprising: a frame structure comprising a plurality of wheels; a siphoning unit comprising a tank drilling device, a pump, a separator vessel, a storage tank, and a plurality of circuit valves all in fluid communication with one another through one or more piping sections; and wherein the siphoning unit is mounted directly or indirectly to the frame: wherein the separator comprises an enclosed vessel comprising a device for increasing flow resistance between an inlet and an outlet to the separator vessel and wherein the pump is configured to discharge fluid to at least one of the separator vessel and the storage tank by actuating one or more of the plurality of circuit valves.

These and other features of the present invention are discussed in further detailed as the same are better understood through a thorough review of the written description and figures.

### BRIEF DESCRIPTION OF THE FIGURES

FIG. 1 shows a function diagram of the device,

FIG. 2 shows a perspective view of the separation vessel in partial section,

FIG. 3 shows a longitudinal section through the separation vessel,

FIG. 4 shows a stack of perforated plate discs as flow resistor

FIG. 5 schematically shows a device for siphoning off fuel from a fuel tank, and

FIG. 6 shows a device augmented by a cleaning function.

### DETAILED DESCRIPTION

The detailed description set forth below in connection with the appended drawings is intended as a description of the presently preferred embodiments of a device for siphoning provided in accordance with aspects of the present invention and is not intended to represent the only forms in which the present invention may be constructed or utilized. The description sets forth the features and the steps for constructing and using the device for siphoning of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like or similar elements or features.

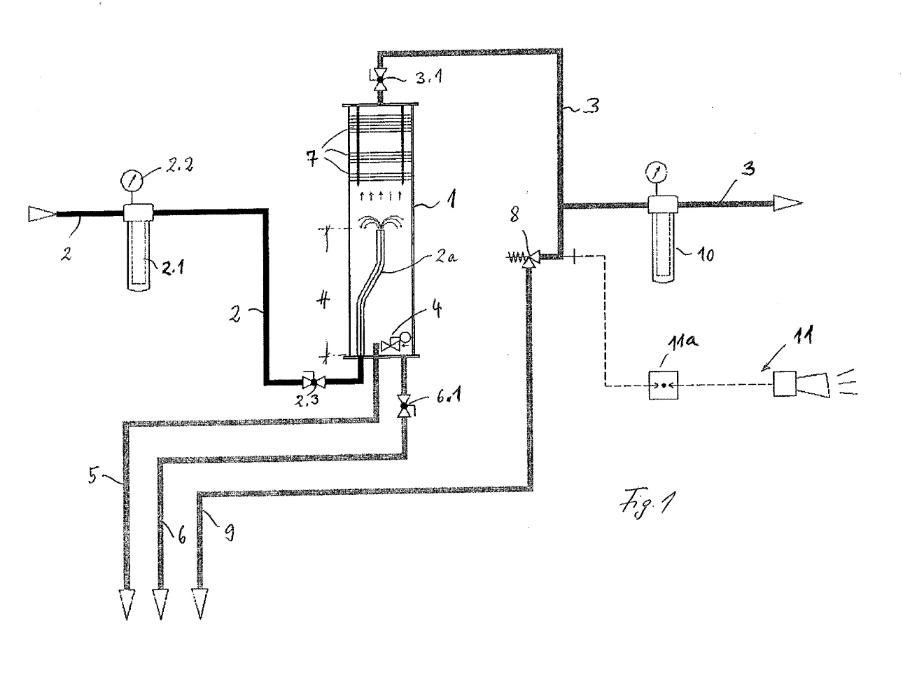

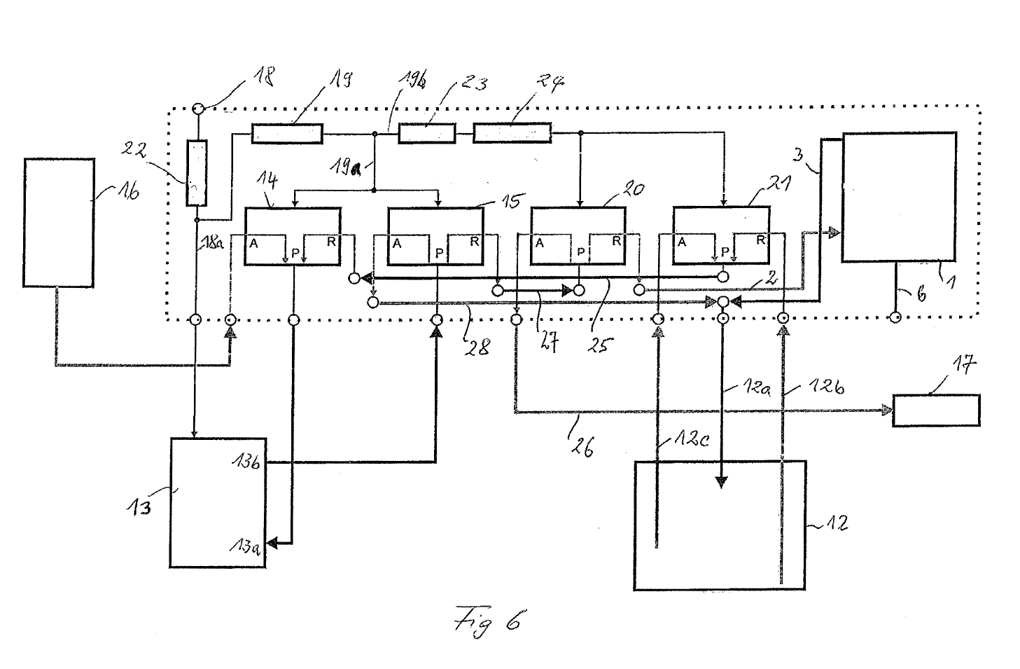

FIG. 1 shows a cylindrical or column-shaped separation vessel 1, into which gasoline containing water as an impurity is introduced by means of a supply pipe 2, wherein the gasoline is withdrawn by suction from the gasoline tank of a vehicle to be scrapped, for example by means of a pump (not shown in FIG. 1). The supply pipe 2 connects to the bottom of the separation vessel 1 and communicates with an inlet distribution section 2a that leads up to a predetermined height H over the bottom of the vessel. A dirt filter 2.1 having a pressure gauge or manometer 2.2 and a check valve 2.3 can be arranged in the supply pipe. At the upper end of the separation vessel separation vessel 1 a discharge pipe 3 opens out, through which cleaned gasoline is discharged to a storage tank 12, shown in FIGS. 5 and 6. In the discharge pipe 3, a check valve 3.1 may be provided near the outlet of the separation vessel 1 to minimize or prevent backflow.

At the bottom of the separation vessel 1, a float valve 4 is arranged, which is connected with a drain pipe 5 through which the water separated from the gasoline is discharged to a collection tank or a dirt tank (not shown). A further or additional drain pipe is designated as 6; which is joined to the bottom of the separation vessel 1. By means of manual operation of a hand valve or block valve 6.1, such as a stop-cock, water collected at the bottom of the separation vessel 1 can be drained off to the dirt or collection tank.

In the upper part of the separation vessel 1, before the opening of the delivery pipe 3, a stack of perforated plate discs 7 are arranged, which form a flow resistor so that the flow speed of the mixture emerging from the opening of the supply pipe 2 is decelerated and the mixture calmed, so that the water contained in the mixture can settle at the bottom of the separation vessel 1 due to gravity. As soon as the water separated from the mixture reaches a certain fill level in the separation vessel 1, the float valve 4 opens so that the separated water is discharged through the drain pipe 5 into the dirt tank.

In the discharge pipe 3, a water stop filter 10 can be arranged which filters fluid in the discharge pipe 3 and particularly water in the discharged fluid in the event water escapes through the perforated discs 7 so that water is prevented from entering the storage tank 12 (FIGS. 5 and 6) for scrubbed or cleaned gasoline.

Further, it is advantageous to provide a pressure control valve 8 in the discharge pipe 3 through which a connection is made to the dirt tank (not shown) via a pipe 9 to regulate high pressure in the discharge pipe 3. This pressure control valve 8 can be connected to an alarm means 11 having a manometric switch 11a which emits, for example, an acoustic signal when high pressure occurs or which sends an electrical signal to a control room to alert an operator of the high pressure condition. In another embodiment, a pressure relief valve having a pre-determined pressure release point that opens when reached is used instead of the pressure control valve.

As FIG. 1 shows, the supply pipe 2 preferably connects off-center or excentrically at the bottom of the separation vessel 1 so that when the column-shaped separation vessel 1 has a small diameter, sufficient interior space remains for placement of the float valve 4. The inlet distribution section 2a of the supply pipe 2 opens out approximately halfway up the separation vessel 1. In an embodiment, the inlet distribution section 2a has a simple pipe opening. In other embodiments, spray nozzles or inlet header comprising a plurality of openings are provided at an end of the inlet distribution section 2a.

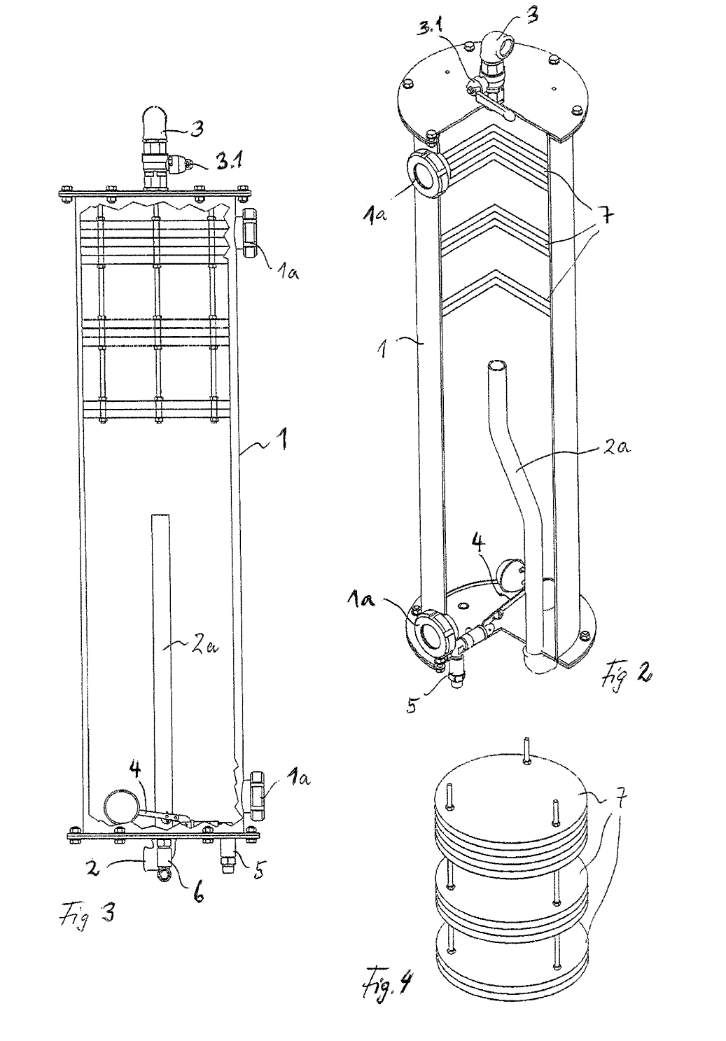

FIGS. 2 and 3 show viewing windows 1a at the upper and lower ends of the separation vessel 1 so that the knock-out state in the vessel can be checked optically. In other embodiments, an external level gauge, such as a bypass level indicator, is provided on the exterior of the separation vessel 1 so that the level may be viewed by observing the external level gauge.

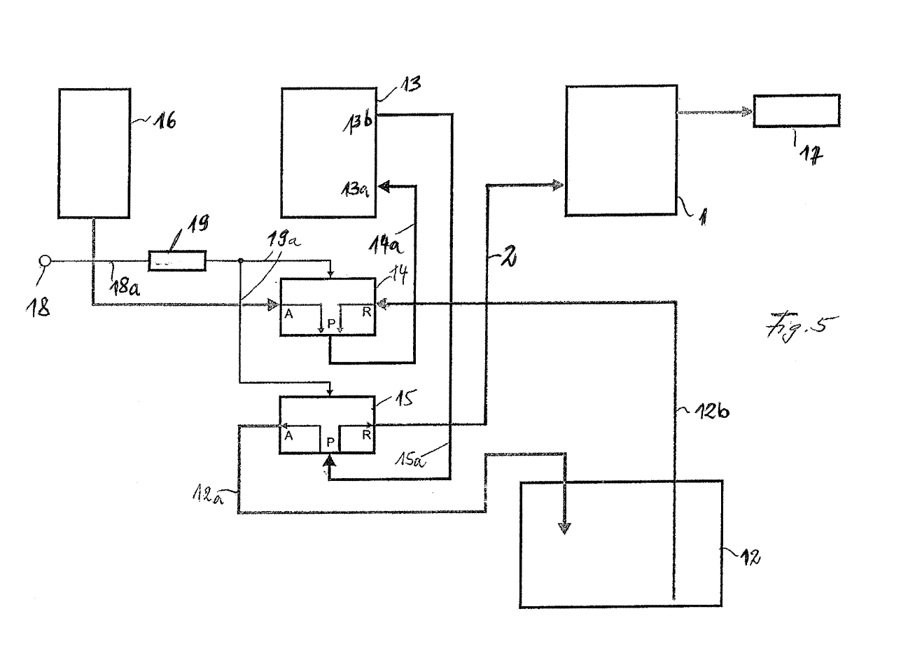

The stack of assembled perforated plate discs 7 is shown in FIG. 4. In one embodiment, the stack is assembled such that three groups of discs 7 are arranged at a distance from each other. In one embodiment, the number of discs increases from the lower group to the upper group. For example, the stack of discs may be assembled in groups of three, four and six perforated discs, respectively. In alternative embodiments, instead of perforated plate discs 7, a different flow resistor can also be arranged in the vessel 1 for calming and decelerating the rising flow of the mixture, for example impingement filter discs.

The separation vessel is operated, for example, at a pressure of 4 bars, wherein a throughput of 20 l/min. can be provided. However, the vessel may be engineered to work at different pressure and flow rate depending on the required application.

The separation vessel 1 can have a diameter of, for example, 30 cm and a height of approximately 120 cm. For transport to the respective job site, the separation vessel 1 can be mounted on a frame provided with wheels. In other embodiments, the framed structure with wheels may be motorized and has a controller for controlling the maneuverability of the device.

During operation of the device, the mixture is firstly pumped through the particle filter 2.2 towards the separation vessel 1. The particle filter 2.2 is equipped with a manometer comprising a color scale, such as green and red, or a numeric scale. When the pointer reaches the red area, which indicates large differential pressure or dirty filter, it is signalled that the filter element should be changed. For this, an acoustic warning can be provided by means of a manometric switch valve, as shown by 11 in FIG. 1. 100271 The mixture flows through the supply pipe 2 into the separation vessel 1, wherein the flow is calmed and decelerated by the perforated plate discs 7 so that water contained in the mixture impacts the perforated plate discs 7 and settles towards the bottom laterally at the inner circumference of the separation vessel 1. Gasoline separated from the water flows through the discharge pipe 3 due to the pressure built up in the vessel 1.

The water stop filter 10 blocks the discharge pipe 3 as soon as the water level in the filter 10 has reached a certain height. Due to the resultant build-up of pressure, the pressure control valve 8 is actuated and the fluid is discharged via the pipe 9 into the dirt tank. In other words, the water stop filter 10 is a combination water/fuel separator, level controller, and control valve that filters water particles from the discharge flow and that can shuts the discharge line 3 if the water level in the filter housing reaches a certain point, such as a certain water level. Exemplary water stop filters 10 include the SEPAR 2000 inline filter and PALLSORB filter from Pall Industrial Hydraulics.

The water stop filter 10 is likewise provided with a manometer which can be formed in the same way as the manometer at the particle filter 2.2.

The device is not only suitable for separating gasoline and water. It can also be used for separating other fluids having different specific weights, such as heating oil, diesel fuel, and engine oil.

The knock-out device described by means of FIGS. 1 to 4 is preferably mounted together with a pump and circuit valves on a moveable framework, at which a tank drilling device can also be provided, by means of which the tank of a motor vehicle to be scrapped is drilled open for siphoning off the fuel and a connection is made to the pump. As used herein, circuit valves are valves that operate in a fluid flow circuit, whether gas or liquid or both. Circuit valves can include a combination manometer or pressure gauge and control valve that can be regulated based on fluid level, pressure reading, and/or gauge reading.

FIG. 5 shows schematically the construction of such a device with the separation vessel 1, a pump 13, two circuit valves 14 and 15 and a tank drilling device 16, wherein a pump nozzle 17 is attached at the separation vessel 1 and by means of this an available vehicle can be directly fueled with the fuel which is siphoned off from the storage tank 12, which may be any number of tanks or reservoirs for which fuel is to be recovered by the system and method of the present invention. The tank drilling device 16 is used to drill a reservoir of fuel to be recovered, the source of which is used by the separation device of the present embodiment. Exemplary tank drilling device 16 includes those made available from SEDA of Austria. In other embodiments, an accessible reservoir may be available without drilling.

The device in FIG. 5 has a compressed-air connection 18 and a pneumatic switch 19 in a compressed air pipe 18a which branches off downstream from the switch 19 at 19a to the two circuit valves 14 and 15. The circuit valve 14 is connected to the inlet 13a of the pump 13 and the circuit valve 15 is connected to the outlet 13b of the pump 13, in each case at the connection point P, via a pipe 14a or 15a. The pump may be an air driven type positive displacement pump, such as a double-diaphragm pump.

The circuit valve 14 is connected at the connection point A to the tank drilling device 16 and at the connection point R to the storage tank 12.

The circuit valve 15 is connected at the connection point A to the storage tank 12 and at the connection point R to the separation vessel 1.

With the device according to FIG. 5, fuel can be conveyed from the motor vehicle to be scrapped via the tank drilling device 16 into the storage tank 12 or to the pump nozzle 17 through the pump 13. The pump nozzle 17 may be viewed as a nozzle or connection point for use to fill a car, a canister, etc. of fuel obtained from the device. For filling the storage tank 12, the circuit valve 14 is switched such that the connections A and P are connected, so that the fuel siphoned off by the tank drilling device 16 is conveyed via the pipe 14a to the pump 13 and from this via the pipe 15a to the circuit valve 15, which is also switched such that the connections A and P are connected to each other, so that the fuel is conveyed via the pipe 12a into the storage tank 12.

When fuel is to be conveyed to the pump nozzle 17 (for providing a fuelling function or tanking function), the two valves 14 and 15 are switched such that the connections R and P are connected to each other, so that fuel from the storage tank 12 is pumped off through the pump 13 via the take-off pipe 12b, via the circuit valve 14 and via the circuit valve 15 and the separation vessel 1 to the pump nozzle 17. The pipe 2 in FIG. 5 between the circuit valve 15 and the separation vessel 1 corresponds to the supply pipe 2 in FIG. 1.

The tank drilling device 16 and the pump 13 are operated by compressed air, wherein the corresponding compressed-air pipes between compressed air connection 18 and these devices 13 and 16 are not shown. The circuit valves 14 and 15 are also switched by compressed air via the pneumatic switch 19.

For switching the flow directions, the two compressed-air driven three-way valves 14 and 15 are simultaneously switched by the two-way pneumatic switch 19.

During filling operation of the tank 12, the valves 14 and 15 are not triggered, so that the flow path from the tank drilling device 16 to the pump inlet 13a and from the pump outlet 13b to the storage tank 12 is free. During fuel delivery at the pump nozzle 17, the two valves 14 and 15 are triggered by compressed air, so that the paths from P to R are open and the flow path of the delivery pipe 12b from the storage tank 12 to the pump inlet 13a and from the pump outlet 13b to the pump nozzle 17 via the separation vessel is free.

FIG. 6 shows a device with four circuit valves 14, 15, 20 and 21, which in the basic position each valve makes a connection between the connections A and P and in the switched position each makes a connection between connections P and R. With this device, it is possible to carry out the function of “cleaning the fuel” by means of the pump nozzle 17 as well as the above described functions of “filling the storage tank” and “fuelling”.

In this device according to FIG. 6, a switch 22 is provided in the pipe 18a leading from the compressed-air connection 18 to the pump 13, and the pump 13 and the switch 19 are supplied with compressed air via this switch 22. The switch 19 simultaneously controls the circuit valves 14 and 15 as in the device according to FIG. 5. A sensor 23 in the pipe 19a downstream of the connection point of the circuit valves 14 and 15 simultaneously actuates the compressed-air driven three-way valves 20 and 21, wherein the sensor is followed in series by a time switch 24 in the form of a throttle valve which adjusts the turn-on time of these valves 20 and 21 by allowing the pressure to slowly escape.

During the “filling” function of the storage tank 12 via a pipe 12a, none of the three-way valves 14, 15, 20 and 21 are triggered, so that their paths from P to A are open. Thus the flow path from the tank drilling device 16 to the pump inlet 13a via the valve 14 and from the pump outlet 13b to the pipe 12a via the valve 15 is free, from whose connection A a pipe 28 leads to the pipe 12a or to the storage tank 12.

During the “tanking” function via the pump nozzle 17, the two circuit valves 14 and 15 are triggered by means of the switch 19 and the pipe 19a, so that their paths are open from P to R, while at the circuit valves 20 and 21 the paths are open from P to A. This allows fluid drawn from the storage tank 12 to cycle through the four valves and then out through the pump nozzle 17.

Thus the flow path from a take-off pipe 12c opening out at a higher level in the storage tank 12 to the pump inlet 13a via a pipe 25 between the connection P of the circuit valve 21 and connection R of the valve 14 is free, as is the flow path from the pump outlet 13b to the pump nozzle 17, wherein the pump outlet 13b is positioned at connection P of the circuit valve 15 and from the connection R thereof a pipe 27 leads to the connection P of the circuit valve 20, whose connection A is connected via a pipe 26 to the pump nozzle 17.

During the “cleaning gasoline” function that sends fuel to the separator vessel 1 the valves 14 and 15 are triggered such that their paths are open from P to R. By actuating the compressed-air sensor 23 the circuit valves 20 and 21 are actuated, so that their paths are likewise free from P to R. In this circuit, the flow path from the take-off pipe 12b opening out near the bottom of the storage tank 12 to the pump inlet 13a via the circuit valve 21, the pipe 25 and the circuit valve 14 is free, as is the flow path from the pump outlet 13b to the inlet 2 of the separation vessel 1 via the circuit valve 15, the pipe 27 between connection R of the valve 15 and connection P of the valve 20, before which the connection R is connected by the supply pipe 2 to the separation vessel 1. From the outlet 3 of the separation vessel 1, the clean fuel flows to pipe 12a into the storage tank 12. The cleaning process can be interrupted by the pneumatic switch 19.

In both devices according to FIGS. 5 and 6, all the functions can be carried out by the pump 13.

For safety reasons, the take-off pipe 12c, by means of which fuel is conveyed out of the storage tank 12 to the pump nozzle 17, opens out at a distance over the bottom of the storage tank 12, in case water may have collected in the bottom area thereof. Correspondingly, during the cleaning process, fuel is siphoned off from the bottom of the storage tank 12 through the take-off pipe 12b.

In FIG. 6 a dotted line indicates a circuit block which can be mounted at the separation vessel 1 and is connectable to the tank drilling device 16, the pump 13, the storage tank 12 and the pump nozzle 17.

Although limited embodiments of devices for siphoning and their components have been specifically described and illustrated herein, many modifications and variations will be apparent to those skilled in the art. For example, the various valves may be any number of prior art block valves or control valves, various sized piping or tubing may be used, and different positive displacements pumps may be used. Furthermore, it is understood and contemplated that features specifically discussed for one siphoning device may be adopted for inclusion with another embodiment, provided the functions are compatible. Accordingly, it is to be understood that the devices for siphoning discussed herein and their components constructed according to principles of this invention may be embodied other than as specifically described herein. The invention is also defined in the following claims.

1. Device for siphoning off fuel from a reservoir comprising:
a tank drilling device, a pump, two circuit valves, a storage tank, and a pump nozzle,
wherein the two circuit valves are switchable between tank drilling device and the pump such that the pump conveys fuel from the tank drilling device to the storage tank or to the pump nozzle, and
wherein the device is provided with a compressed-air connection and the tank drilling device, the pump, and the two circuit valves are operable by compressed air.

2. The device according to claim 1, further comprising a second pair of circuit valves, said second pair of circuit valves are switchable in connection with the two circuit valves such that fuel is conveyed from the storage tank to a separator vessel and conveyable from the separation vessel back to the storage tank.

3. The device according to claim 2, wherein a take-off pipe connects to the storage tank and is in fluid communication with the separator vessel, the two circuit valves, and the second pair of circuit valves.

4. Device for separating water and fuel, comprising:
a separator vessel having a supply pipe for an inlet flow of mixture of fuel and water at a first fuel to water ratio, and a discharge pipe for an outlet flow of fuel and water at a second fuel to water ratio,
wherein a device for increasing flow resistance is provided between the supply pipe and the discharge pipe inside the separator vessel so that the second fuel to water ratio is substantially higher than the first fuel to water ratio, and
a drain pipe for water is provided on the separator vessel.

5. The device according to claim 4, wherein a float valve is provided for providing fluid flow through the drain pipe when a predetermined fill level of water is reached in the separator vessel.

6. The device according to claim 4, wherein the supply pipe is guided excentrically through the bottom of the separator vessel and has a cranked end portion which ends inside the separator vessel approximately halfway up.

7. The device according to claim 4, wherein the drain pipe is connected to a check valve to limit fluid flow into the separator vessel by way of the drain pipe.

8. The device according to claim 4, wherein a water stop filter is arranged with the discharge pipe to automatically block fluid flow downstream of the water stop filter when a predetermined fill level of water is reached in the water stop filter.

9. The device according to claim 8, wherein a pressure control valve is arranged in the discharge pipe and connects the discharge pipe to a collection tank.

10. The device according to claim 9, wherein a manometric switch with alarm output capability is connected to the pressure control valve.

11. The device according to claim 4, wherein the device for increasing flow resistance is formed in the form of perforated discs which are arranged in a stack before an opening leading to the discharge pipe in the separator vessel.

12. The device according to claim 11, wherein the perforated plate discs are arranged in groups that are spaced apart from each other.

13. A device for separating water and fuel comprising:
a frame structure comprising a mounting surface;
a siphoning unit comprising a pump, a separator vessel, a storage tank and a plurality of circuit valves all in fluid communication with one another through one or more piping sections; and wherein the siphoning unit is mounted directly or indirectly to the frame;
wherein the separator comprises an enclosed vessel comprising a device for increasing flow resistance between an inlet and an outlet to the separator vessel; and
wherein the pump is configured to discharge fluid to at least one of the separator vessel and the storage tank by actuating one or more of the plurality of circuit valves.

14. The device of claim 13, further comprising a plurality of wheels attached to the frame.

15. The device of claim 14, wherein the plurality of wheels comprise at least one pivotable caster wheel.

16. The device of claim 13, wherein the device for increasing flow resistance comprises two or more generally planar discs.

17. The device of claim 16, wherein the generally planar discs are perforated.

18. The device of claim 13, further comprising a tank drilling device adapted to drill into a reservoir to obtain fluid flow for the pump.
